(19) United States
(12) Patent Application Publication
(10) Pub. No.: US 2024/0294783 A1
(43) Pub. Date: Sep. 5, 2024

(54) ACRYLAMIDE POLYMER INVERSE EMULSIONS CONTAINING RHEOLOGY MODIFIERS AND ARCHITECTURAL COATING COMPOSITIONS DERIVED THEREFROM

(71) Applicant: HERCULES LLC, Wilmington, DE (US)

(72) Inventors: Venkataram KRISHNAN, Avondale, PA (US); Zeena Kottukapally CHERIAN, Exton, PA (US)

(21) Appl. No.: 18/278,548

(22) PCT Filed: Feb. 23, 2022
(86) PCT No.: PCT/US22/17476

§ 371 Date: Aug. 23, 2023

Related U.S. Application Data
(60) Provisional application No. 63/152,532, filed on Feb. 23, 2021.

(51) Int. Cl. C09D 7/44; C08L 1/28

(52) U.S. Cl. CPC C09D 7/44; C08L 1/284

(57) ABSTRACT

The presently disclosed inventive concept(s) relate generally to a rheology-modifier composition comprising 0.05 wt. % to 70.0 wt. % of an inverse emulsion of acrylamide polymer, and 30.0 wt. % to 99.95 wt. % of at least one cellulose ether, wherein the cellulose ether can be in dry powder form or in fluidized polymer suspension form. Further, the presently disclosed inventive concept(s) also relate to a method of making the rheology modifier composition and an aqueous coating composition comprising the present rheology modifier composition.

### FIELD OF THE INVENTION

The presently disclosed process(es), procedure(s), method(s), product(s), result(s), and/or concept(s) (collectively referred to hereinafter as the “present disclosure”) relates generally to rheology modifier compositions containing an inverse emulsion of acrylamide polymers and applications thereof. The present disclosure further relates to architectural coating composition(s) derived from the rheology modifier compositions.

### BACKGROUND OF THE INVENTION

Hydrophobically modified non-ionic synthetic thickeners (NSAT) such as hydrophobically modified ethylene-oxide based polyurethanes (HEUR) generally known as associative rheology modifiers are widely used to thicken or increase the viscosity of a paint to bring optimum application properties such as levelling, sag resistance and the like. These rheology modifiers contain two or more hydrophobes. The function of the hydrophobes is to associate with the surface of the binder latex particles resulting in a network structure that links together individual latex particles thus increasing the viscosity. Also used in the coating industry are non-associative rheology modifiers. Examples of non-associative rheology modifiers include water-soluble polymers, for example, cellulosic (HEC), starches and the like. Non-associative rheology modifiers increase the viscosity of paint through a thickening mechanism introduced by highly entangled polymer molecules in aqueous solution thus restricting the mobility of the paint. The individual use of polyacrylamides and cellulose ethers, for example, hydroxyethyl cellulose, as non-associative thickeners is known in the related art, nevertheless they have been known to have certain deficiencies, such as, stringy or gloppy rheology, poor levelling and dilution tolerance.

European Patent No. 0042678 to Scott Bader Co. Ltd. discloses a thickener for aqueous based compositions wherein the thickener is a water-in-oil emulsion containing water soluble polyacrylamide or polymethacrylamide homopolymers or copolymers with other suitable monomers such as acrylic acid or methacrylic acid.

U.S. Pat. No. 5,521,234 teaches Fluidized Polymer Suspension (FPS) thickeners of hydroxyethyl cellulose and/or alkyl or arylalkyl hydrophobically modified hydroxyethyl cellulose and its use in aqueous coating compositions.

Therefore, there is a long-felt need in the art to provide rheology modifier compositions that overcome the drawbacks of the prior art compositions and provide a cost-effective rheology modifier composition with some unanticipated benefits such as improved thickening efficiency, high sag resistance and dilution tolerance, and cost in use.

### SUMMARY OF THE INVENTION

One aspect of the present disclosure provides a rheology modifier composition comprising a blend of (i) 0.05 wt. % to 70.0 wt. % of an inverse emulsion of acrylamide polymer; and (ii) 30.0 wt. % to 99.95 wt. % of at least one cellulose ether. In one non-limiting embodiment of the present disclosure, the acrylamide polymer includes a non-ionic homopolymer or an anionic copolymer or a cationic copolymer. In one non-limiting embodiment of the present disclosure, the acrylamide polymer is a cationic polymer. In one non-limiting embodiment of the present disclosure, the weight average molecular weight of acrylamide polymer varies in the range of from about 0.05 million Daltons to about 15 million Daltons. In one non-limiting embodiment of the present disclosure, the cellulose ether is a glyoxal treated cellulose ether or non-glyoxal treated cellulose ether. In another non-limiting embodiment of the present disclosure, the cellulose ether is hydroxyethyl cellulose or carboxymethyl cellulose either alone or in combination thereof. In another non-limiting embodiment of the present disclosure, the cellulose ether is non-glyoxal treated hydroxyethyl cellulose. In yet another embodiment of the present disclosure, the cellulose ether is glyoxal treated hydroxyethyl cellulose. In one non-limiting embodiment of the present disclosure, the cellulose ether is in a dry powder form or in a fluidized polymer suspension form.

Another aspect of the present disclosure provides a method of preparing the above-described rheology modifier composition, the method comprising blending (i) 0.05 wt. % to 70.0 wt. % of an inverse emulsion of acrylamide polymer; and (ii) 30.0 wt. % to 99.95 wt. % of at least one cellulose ether, wherein the cellulose ether is in dry powder form or in a fluidized polymer suspension form.

Still another aspect of the present disclosure contemplates the use of a rheology modifier composition of the present disclosure in aqueous-based coatings, the composition comprising a blend of (i) 0.05 wt. % to 70.0 wt. % of an inverse emulsion of acrylamide polymer; and (ii) 30.0 wt. % to 99.95 wt. % of at least one cellulose ether, wherein the cellulose ether is in dry powder form or in a fluidized polymer suspension form.

Yet another aspect of the present disclosure provides an aqueous coating composition comprising: (ia) 0.01 wt. % to 10.0 wt. % of the rheology modifier composition of the present disclosure or (ib) 0.01 wt. % to 10.0 wt. % of an inverse emulsion of acrylamide polymer, and 0.01 wt. % to 10.0 wt. % of at least one cellulose ether; (ii) 5.0 wt. % to 85.0 wt. % of at least one film forming polymer; and (iii) 5.0 wt. % to 15.0 wt. % of water, based on the total weight of the aqueous coating composition. In one non-limiting embodiment of the present disclosure, the aqueous coating composition is an architectural coating composition.

### DETAILED DESCRIPTION OF THE INVENTION

Before explaining at least one embodiment of the inventive concept(s) in detail by way of exemplary drawings, experimentation, results, and laboratory procedures, it is to be understood that the inventive concept(s) is not limited in its application to the details of construction and the arrangement of the components set forth in the following description or illustrated in the drawings, experimentation and/or results. The inventive concept(s) is/are capable of other embodiments or of being practiced or carried out in various ways. As such, the language used herein is intended to be given the broadest possible scope and meaning; and the embodiments are meant to be exemplary, not exhaustive. Also, it is to be understood that the phraseology and terminology employed herein is for the purpose of description and should not be regarded as limiting.

Unless otherwise defined herein, scientific and technical terms used in connection with the present disclosure shall have the meanings that are commonly understood by those of ordinary skill in the art. Further, unless otherwise required by context, singular terms shall include pluralities and plural terms shall include the singular. Generally, nomenclatures utilized in connection with, and techniques of chemistry described herein are those well-known and commonly used in the art. Reactions and purification techniques are performed according to manufacturer's specifications or as commonly accomplished in the art or as described herein.

All patents, published patent applications, and non-patent publications mentioned in the specification are indicative of the level of skill of those skilled in the art to which this present disclosure pertains. All patents, published patent applications, and non-patent publications referenced in any portion of this application are herein expressly incorporated by reference in their entirety to the same extent as if each individual patent or publication was specifically and individually indicated to be incorporated by reference.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the inventive concept(s) as defined by the appended claims.

As utilized in accordance with the present disclosure, the following terms, unless otherwise indicated, shall be understood to have the following meanings:

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, and/or the variation that exists among the study subjects. The use of the term “at least one” will be understood to include one as well as any quantity more than one, including but not limited to, 2, 3, 4, 5, 10, 15, 20, 30, 40, 50, 100, etc. The term “at least one” may extend up to 100 or 1000 or more, depending on the term to which it is attached; in addition, the quantities of 100/1000 are not to be considered limiting, as higher limits may also produce satisfactory results. In addition, the use of the term “at least one of X, Y and Z” will be understood to include X alone, Y alone, and Z alone, as well as any combination of X, Y and Z.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, MB, BBC, AAABCCCC, CBBAAA, CABABB, and so forth. The skilled artisan will understand that typically there is no limit on the number of items or terms in any combination, unless otherwise apparent from the context.

As used herein, the term “acrylamide polymer” means a polymer formed by polymerizing acrylamide based repeating monomeric units wherein the acrylamide based repeating units may be a acrylamide or a acrylamide substituted on the alpha-carbon atom or on the nitrogen atom.

As used herein, the term “inverse emulsion” means a water-in-oil emulsion comprising oil as a continuous phase and an aqueous solution or a gel as a discontinuous phase/dispersed phase, wherein the aqueous phase comprises one or more water soluble or water dispersible polymers, such as acrylamide polymer.

As used herein, the term “aqueous coatings” has its art-recognized meaning which allows for the inclusion of minor amounts of co-solvents and other volatile organic material provided water constitutes more than 50%, and preferably at least 80% of the volatile phase so that even with the presence of organic solvents these coatings are still regarded as water-borne, since the majority of the volatile solvent present in the liquid coating composition is water.

As used herein, the term “architectural coatings” refers to those water borne paints which are characterized in that a resinous binder is solubilized, dispersed or emulsified in an aqueous phase, commonly referred to as the continuous phase which is predominantly water. Suitable water-borne binders can include materials such as starch, modified starch, polyvinyl alcohol, polyvinyl acetate, polyethylene/acrylic acid copolymer, acrylic acid polymers, polyacrylate, polyacrylamide copolymers, acrylonitrile/butadiene/styrene copolymers and polyacrylonitrile. Suitable and non-limiting examples of water-insoluble binders can include polyacrylates, methacrylates, vinyl-acrylics, styrene-acrylics and the like.

One aspect of the present disclosure provides a rheology modifier composition. The rheology modifier composition of the present disclosure comprises a blend of an inverse emulsion of acrylamide polymer; and at least one cellulose ether.

The inverse emulsion of acrylamide polymer used in the rheology modifier composition of the present disclosure is a water-in-oil emulsion of acrylamide polymer comprising water as a discontinuous phase dispersed in at least one oil phase as a continuous phase. The acrylamide polymer is solubilized in the discontinuous water phase. The inverse emulsion or water-in-oil emulsion of acrylamide polymer can further comprise one or more emulsifying surfactants and one or more inverting surfactants.

The inverse emulsion of acrylamide polymers useful for the purpose of the present disclosure can be prepared by conventional methods known in the related art. Alternatively, commercially available polymers products can also be procured. Suitable examples of such products can include, but are not limited to, PRAESTOL N3100 LTR, PRAESTOL N3100 L, PRAESTOL A3040 LAD, PRAESTOL A3015 L, PRAESTOL 3019L (available from Solenis); and FLOPAM EM 230 and FLOPAM DW 230 from SNF.

The relative amounts of components of the inverse emulsion of acrylamide polymer may vary over a wide range. In one non-limiting embodiment of the present disclosure, the inverse emulsion of acrylamide polymer can comprise from about 5.0 wt. % to about 90.0 wt. % of water, from about 5.0 wt. % to about 90.0 wt. % of the oil phase, from about 2.0 wt. % to about 90.0 wt. % of the acrylamide polymer solid, and from about 0.1 wt. % to about 10.0 wt. % of the surfactants, including inverting surfactants and emulsifying surfactants, wherein all wt. % values are based on the total weight of the inverse emulsion of acrylamide polymer.

In one embodiment of the present disclosure, the oil phase of the inverse emulsion of acrylamide polymer can be selected from a large group of organic liquids which can include liquid hydrocarbons or substituted liquid hydrocarbons. Further, the hydrocarbon liquids and/or substituted hydrocarbons liquids can both be aliphatic hydrocarbons as well as aromatic hydrocarbons. Suitable examples of such organic liquids can include, but are not limited to, benzene, xylene, toluene, mineral oils, kerosene, napthas, petroleums, blends of aromatic and aliphatic hydrocarbons containing 4 or greater carbon atoms, vegetable oils, paraffinic hydrocarbon oils, and combinations thereof.

In one non-limiting embodiment of the present disclosure, the oil phase can be present in an amount of from about 5.0 wt. % to about 90.0 wt. % of the inverse emulsion of acrylamide polymer. In another non-limiting embodiment of the present disclosure, the amount can vary from about 10.0 wt. % to about 20.0 wt. % or from about 20.0 wt. % to about 30.0 wt. % or from about 30.0 wt. % to about 40.0 wt. % or from about 50.0 wt. % to about 60.0 wt. % or from about 60.0 wt. % to about 70.0 wt. % or from about 70.0 wt. % to about 80.0 wt. % or from about 80.0 wt. % to 90.0 wt. %, based on the total weight of the inverse emulsion of acrylamide polymer.

In one non-limiting embodiment of the present disclosure, any suitable surfactant that provides stable water-in-oil emulsion polymers can be used in the present inverse emulsion of acrylamide polymer. Suitable examples of such surfactants can include, but are not limited to, alkanolamides, polyoxyethylene derivatives of sorbitan esters, sorbitan monooleate, sorbitan monostearate, C₆-C₂₂ linear or branched alkyl ethoxylates with 1 to 30 oxyethylene units, C₆-C₂₂ linear or branched alkyl propoxylates with 1 to 30 oxypropylene units, C₆-C₂₂ linear or branched alkyl ethoxylates/propoxylates with 1 to 30 combined oxyethylene and propoxylate units, alkylaryl ethoxylates containing a C₆-C₂₂ aryl group with 1 to 30 oxyethylene units, hexadecyl sodium phthalate, cetyl sodium phthalate, stearyl sodium phthalate, ethylene oxide condensates of fatty acid amides, and mixtures thereof. Other non-limiting examples of suitable surfactant systems can include surfactants disclosed in U.S. Pat. Nos. 4,672,090; 4,772,659; 4,935,456; 3,826,771; 3,278,506; 3,284,393; and 4,070,323.

In one non-limiting embodiment of the present disclosure, the surfactant can be present in an amount of from about 0.1 wt. % to about 10.0 wt. % of the inverse emulsion of acrylamide polymer. In another non-limiting embodiment of the present disclosure, the amount can vary from about 0.5 wt. % to about 8.0 wt. % or from about 0.75 wt. % to about 7.0 wt. % or from about 1.0 wt. % to about 6.0 wt. % or from about 1.0 wt. % to about 5.0 wt. % of the total inverse emulsion of acrylamide polymer.

In one non-limiting embodiment of the present disclosure, the aqueous phase can be present in an amount of from about 5.0 wt. % to about 90.0 wt. % of the total weight of the inverse emulsion of acrylamide polymer. In another non-limiting embodiment of the present disclosure, the amount of aqueous phase can vary from about 10.0 wt. % to 20.0 wt. % or from about 20.0 wt. % to about 30.0 wt. % or from about 30.0 wt. % to about 40.0 wt. % or from 40.0 wt. % to about 50.0 wt. % or from about 50.0 wt. % to about 60.0 wt. % or from about 60.0 wt. % to about 70.0 wt. % or from about 70.0 wt. % to about 80.0 wt. % or from about 80.0 wt. % to about 90.0 wt. %, based on the total weight of the inverse emulsion of acrylamide polymer.

Further, the acrylamide polymer makes up at least 2% of the total inverse emulsion of acrylamide polymer. In one non-limiting embodiment of the present disclosure, the acrylamide polymer can be present in an amount of from about 5.0 wt. % to about 90.0 wt. % or from about 5.0 wt. % to about 10.0 wt. % or from about 10.0 wt. % to about 20.0 wt. % or from about 20.0 wt. % to about 30.0 wt. % or from about 30.0 wt. % to about 40.0 wt. % or from about 40.0 wt. % to about 50.0 wt. % or from about 50.0 wt. % to about 60.0 wt. % or from about 60.0 wt. % to about 70.0 wt. % or from about 70.0 wt. % to about 80.0 wt. % or from about 80.0 wt. % to about 90.0 wt. %, based on the total weight of the inverse emulsion of acrylamide polymer.

The acrylamide polymer according to the present disclosure can be a non-ionic homopolymer, an anionic copolymer or a cationic copolymer. In one non-limiting embodiment of the present disclosure, the acrylamide polymer can be a homopolymer. In another non-limiting embodiment of the present disclosure, the acrylamide polymer can be an anionic copolymer. In yet another non-limiting embodiment of the present disclosure, the acrylamide polymer can be cationic polymer. The anionic copolymer according to the present disclosure comprises at least one monomer unit having one or more acid functional groups or anhydride functional groups, or any combinations thereof, with one or more hetero atoms selected from the group consisting of S, N, O and P. Suitable examples of such monomers can include, but are not limited to, acrylic acid, methacrylic acid, maleic acid or anhydride, itaconic acid or anhydride, acrylamido propane sulfonic acid, vinyl phosphonic acid, and the like. Similarly, suitable examples of cationic polymers can include, but are not limited to, 3-acrylamidopropyl trimethylammonium chloride, 3-methacrylamidopropyl trimethylammonium chloride, and the like.

The acrylamide polymer present in the water-in-oil emulsion of the present disclosure can have a wide molecular weight range. In one non-limiting embodiment of the present disclosure, the acrylamide polymer can have an average molecular weight in the range of from about 0.05 million Daltons to about 15 million Daltons. In one non-limiting embodiment of the present disclosure, the molecular weight of acrylamide polymer can vary in the range of from about 1 million Daltons to about 4 million Daltons, or from about 4 million Daltons to about 8 million Daltons, or from about 8 million Daltons to about 12 million Daltons.

The inverse emulsion of acrylamide polymer can further optionally comprise one or more additional components. Examples of such components can include, but are not limited to, surfactants, dispersants, suspending agents, chelating agents, biocides, stabilizers, and the like.

The inverse emulsion of acrylamide polymer used in the composition of the present disclosure can be prepared by methods known to those skilled in the art. Further, it will be understood by a person having ordinary skill in the art how to appropriately formulate the inverse emulsion composition to provide necessary or desired features or properties.

Further, the cellulose ether used in the rheology modifier composition of the present disclosure can be a glyoxal treated cellulose ether or a non-glyoxal treated cellulose ether. In one non-limiting embodiment of the present disclosure, the cellulose ether is glyoxal-treated cellulose ether. In another non-limiting embodiment of the present disclosure, the cellulose ether is non-glyoxal treated cellulose ether. Suitable examples of such cellulose ethers can include, but are not limited to, hydroxyethyl cellulose (HEC), hydroxypropyl cellulose (HPC), ethyl hydroxyethyl cellulose (EHEC), carboxymethyl cellulose (CMC), carboxymethyl hydroxyethyl cellulose (CMHEC), hydroxypropyl hydroxyethyl cellulose (HPHEC), methyl cellulose (MC), methyl hydroxypropyl cellulose (MHPC), methyl hydroxyethyl cellulose (MHEC), carboxymethyl methylcellulose (CMMC), hydrophobically modified carboxymethyl cellulose (HMCMC), hydrophobically modified hydroxyethyl cellulose (HMHEC). hydrophobically modified hydroxypropyl cellulose (HMHPC), hydrophobically modified ethyl hydroxyethyl cellulose (HMEHEC), hydrophobically modified carboxymethyl hydroxyethyl cellulose (HMCMHEC), hydrophobically modified hydroxypropyl hydroxyethyl cellulose (HMHPHEC), hydrophobically modified methyl cellulose (HM MC), hydrophobically modified methyl hydroxypropyl cellulose (HMMHPC), hydrophobically modified methyl hydroxyethyl cellulose (HMMHEC), hydrophobically modified carboxymethyl methylcellulose (HMCMMC), cationic hydroxyethyl cellulose (cationic HEC), cationic hydrophobically modified hydroxyethyl cellulose (cationic HMHEC), and any combinations thereof. In one non-limiting embodiment of the present disclosure, the cellulose ether can be a glyoxal-treated hydroxyethyl cellulose. In another non-limiting embodiment of the present disclosure, the cellulose ether can be non-glyoxal treated hydroxyethyl cellulose. In another non-limiting embodiment of the present disclosure, the cellulose ether can be hydroxyethyl cellulose or carboxymethyl cellulose either alone or in combination thereof.

Further, the cellulose ether present in the rheology modifier composition of the present disclosure can be in a dry powder form. Alternatively, the cellulose ether can be in a fluidized polymer suspension (FPS) form. In one non-limiting embodiment of the present disclosure, the cellulose ether is in dry powder form. In another non-limiting embodiment of the present disclosure, the cellulose ether is in a fluidized polymer suspension (FPS) form. Any commercially available cellulose ethers can suitably be used in the present disclosure. Suitable examples of such products can include, but are not limited, FPS Natrosol HEC 250 HHRP, FPS Natrosol HEC 250 HHBR, FPS Natrosol Plus 330, FPS Natrosol 250H4BR, FPS Natrosol 250HBR (available in FPS form from Ashland LLC.) and Natrosol HEC H4BR (available in dry powder form from Ashland LLC). Further, the fluidized polymer suspension of cellulose ether, such as hydroxyethyl cellulose can also be prepared by methods known to those skilled in the art, for example, the method as described in the U.S. Pat. No. 5,521,234 assigned to Aqualon.

In one non-limiting embodiment of the present disclosure, the inverse emulsion of acrylamide polymer can be present in an amount of from about 0.05 wt. % to about 50.0 wt. %, or from about 0.05 wt. % to about 30.0 wt. %, based on the total weight of the rheology modifier composition. In another non-limiting embodiment of the present disclosure, the inverse emulsion of acrylamide polymer is a cationic polymer and can be present in an amount of from about 0.05 wt. % to about 50.0 wt. %, or from about 0.05 wt. % to about 30.0 wt. %, based on the total weight of the rheology modifier composition. In another non-limiting embodiment of the present disclosure, the cellulose ether can be present in an amount of from about 50.0 wt. % to about 99.95 wt. %, or from about 70.0 wt. % to about 99.95 wt. %, based on the total weight of the rheology modifier composition. In an embodiment of the present disclosure wherein the cellulose ether is a combination of hydroxyethyl cellulose and carboxymethyl cellulose, their total amount can vary in the range of from about 50.0 wt. % to about 99.95 wt. %, or from about 70.0 wt. % to about 99.95 wt. %, based on the total weight of the rheology modifier composition.

The rheology modifier composition of the present disclosure can further include at least one associative polymer selected from the group consisting of hydrophobically modified ethoxylated urethane polymers, hydrophobically modified polyacetal-polyether polymers, hydrophobically modified alkali swellable emulsions, hydrophobically modified aminoplasts, alkali swellable emulsions and combinations thereof. In one non-limiting embodiment of the present disclosure, the associative polymer is hydrophobically modified polyacetal-polyether polymer.

The rheology modifier composition of the present disclosure can further comprise at least one additive selected from the group consisting of surfactants; dispersants; thickeners; anticaking agents; antifoaming agents; preservatives; hydrophobic agents including waxes, silicones, and hydrocarbons; compatibilizers; adhesion promoters; stabilizers, crosslinkers; and combinations thereof.

Suitable examples of dispersants can include, but are not limited to, polycarboxylic acids, carboxylated polyelectrolyte salts, tripolyphosphate salts and tetrapotassium pyrophosphate, ethoxylated fatty alcohols, amino alcohols, acrylic copolymers, naphthalene sulfonic acid-formaldehyde adducts, sulfonated fatty acids, polyethylene glycol diloeate, soya lecithin, PEG diloeate, polyethylene glycol, polypropylene glycol, methoxy polyethylene glycol, mono stearate polyethylene glycol, di-stearate polyethylene glycol, and combinations thereof.

Further, the rheology modifier composition of the present disclosure can be a liquid blend of the inverse emulsion of acrylamide polymer and the cellulose ether. The liquid blend of the inverse emulsion of acrylamide polymer and cellulose ether can be prepared by blending the inverse emulsion of acrylamide polymer and the cellulose ether.

Another aspect of the present disclosure provides a method of preparing the present rheology modifier composition, wherein the method comprises blending the inverse emulsion of acrylamide polymer and at least one cellulose ether. In one non-limiting embodiment of the present disclosure, the cellulose ether can be in dry powder form. In another non-limiting embodiment of the present disclosure, the cellulose ether can be in fluidized polymer suspension form. Any known blending techniques or apparatus which are well-known in the art to the skilled artisan can suitably be used to blend the inverse emulsion of acrylamide polymer and the cellulose ether to prepare the rheology modifier composition of the present disclosure. In an embodiment of the present disclosure, wherein the cellulose ether is in fluidized polymer suspension form, blending of the inverse emulsion of acrylamide polymer and the fluidized polymer suspension (FPS) of cellulose ether can be carried out during designing and manufacturing of the FPS form of cellulose ether.

Further, the cellulose ether can be used in an amount of from about 30.0 wt. % to about 99.95 wt. %, or from about 50.0 wt. % to about 99.97 wt. %, or from about 70.0 wt. % to about 99.95 wt. %, based on the total weight of the rheology modifier composition. Similarly, the inverse emulsion of acrylamide polymer can be used in an amount of from about 0.05 wt. % to about 70.0 wt. % or from about 0.05 wt. % to about 50.0 wt. % or from about 0.05 wt. % to about 30.0 wt. %, based on the total weight of the present rheology modifier composition.

Further, additional additives can also be added during the preparation of the present rheology modifier composition. Such additives can include at least one additive selected from the group consisting of surfactants; dispersants; thickeners; anticaking agents; antifoaming agents; preservatives; hydrophobic agents including waxes, silicones, and hydrocarbons; compatibilizers; adhesion promoters; crosslinkers; and any combinations thereof.

The rheology modifier composition of the present disclosure can be used in aqueous coating compositions. In particular, the rheology modifier composition of the present disclosure is useful in all kinds of coatings, such as decorative and protective coatings, and in paper coatings. The aqueous protective coating compositions are commonly known as latex paints or dispersion paints and have been known for a considerable number of years. The rheology modifiers used in the aqueous coating composition increase and maintain the viscosity at required levels under specific processing conditions and end use situations. The aqueous protective coating composition desirably provide good levelling and excellent sag resistance through the judicious choice of rheology modifiers. Another aspect of the present disclosure provides a use of the rheology modifier composition of the present disclosure in aqueous based coatings, wherein the composition comprising a blend of (i) 0.05 wt. % to 70.0 wt. % of an inverse emulsion of acrylamide polymer; and (ii) 30.0 wt. % to 99.95 wt. % of at least one cellulose ether.

Another aspect of the present disclosure provides an aqueous coating composition comprising the rheology modifier composition of the present disclosure as described hereinabove. The aqueous coating composition comprises the rheology modifier composition comprising the inverse emulsion of acrylamide polymer and at least one cellulose ether; at least one film forming polymer; and water.

The amount of the rheology modifier composition used in the aqueous coating composition of the present disclosure is an amount effective in providing the desired thickening and rheological properties to the aqueous coating composition and thus will depend upon both the rheological properties desired and the dispersion employed. Further, the rheology modifier composition can be added as a liquid blend comprising the inverse emulsion of acrylamide polymer and at least one cellulose ether in the aqueous coating composition of the present disclosure. Alternatively, the inverse emulsion of acrylamide polymer and the cellulose ethers can be added individually in the aqueous coating composition of the present disclosure.

In an embodiment of the present disclosure, wherein the rheology modifier composition can be added as a liquid blend in the aqueous coating composition, the amount of rheology modifier composition added can vary in the range of from about 0.01 wt. % to 10.0 wt. %, based on the total weight of the aqueous coating composition. In another non-limiting embodiment of the present disclosure, the amount varies in the range of from about 0.05 wt. % to about 5 wt. % of the total weight of the aqueous coating composition.

In an embodiment of the present disclosure wherein the acrylamide polymer and the cellulose ether are added individually, their respective amounts typically vary in the range of from about 0.01 wt. % to about 10.0 wt. % of the total aqueous coating composition weight. The acrylamide polymer and the cellulose ether, when added individually in the aqueous coating composition, are present as a synergistic dry blend thereof. Even in this case, their combined weight proportion varies in the range of from about 0.01 wt. % to about 10.0 wt. %, or from about 0.05 wt. % to about 5.0 wt. % of the total aqueous coating composition weight.

The aqueous coating composition of the present disclosure is an aqueous polymer dispersion comprising at least one film forming polymer. The film forming polymer used in the aqueous coating composition of the present disclosure can be selected from a wide variety of polymers known in the related art. For instance, these film forming polymers can be derived from various ethylenically unsaturated monomers such as ethylene, vinyl and acrylic monomers. Examples of such monomers can include, but are not limited to, acrylic acid, methacrylic acid, methacrylic acid esters, styrene, a-methyl styrene, vinyl chloride, acrylonitrile, methacrylonitrile, ureido methacrylate, vinyl acetate, vinyl esters of branched tertiary monocarboxylic acids, itaconic acid, crotonic acid, maleic acid, fumaric acid, and ethylene. It is also possible to include C4-C8 conjugated dienes such as 1,3-butadiene, isoprene and chloroprene. The film forming polymers can also be copolymerized products of more than one monomer to achieve several desired properties, particularly for applications in latex paints with very little or no volatile organic compounds (VOCs). Examples of suitable film forming polymers can include, but are not limited to, homo-or co-polymers of vinyl acetate, methacrylic acid, methylacrylate, methylmethacrylate, ethylacrylate, butyl acrylate, styrene, ethylene, vinyl chloride, vinyl ester of versatic acid (VeoVa), vinyl propionate, butadiene, acrylonitrile, maleates, and fumarates. In one non-limiting embodiment of the present disclosure, the film forming polymer is selected from the group consisting of acrylics, vinyl-acrylics and styrene-acrylics, styrene-butadiene copolymers, vinyl acetate ethylenes, butadiene-acrylonitrile copolymers, epoxides, urethanes, polyamides, vinyl esters of versatic acid (VeoVa), and polyesters.

Examples of other suitable film forming polymers can include, but are not limited to, alkyds, cellulosics (cellulose nitrate and cellulose esters), coumarone-indenes, epoxies, esters, hydrocarbons, melamines, natural resins, oleo resins, phenolics, polyamides, polyesters, rosins, silicones, terpenes, urea, and urethanes.

The amount of film forming polymer in the aqueous coating composition of the present disclosure varies in the range of from about 5.0 wt. % to about 85.0 wt. %, based on the total aqueous coating composition weight. In one non-limiting embodiment, the amount of film forming polymer can vary from about 40.0 wt. % to about 70.0 wt. %, or from about 50.0 wt. % to about 70.0 wt. %, based on the total aqueous composition weight.

The aqueous coating composition of the present disclosure can further include at least one pigment. The pigment can be selected from the group consisting of phthalocyanines, iron oxides, titanium dioxides, zinc oxide, indigo, hydrated aluminum oxide, barium sulfate, calcium silicate, clay, silica, talc, calcium carbonate, and mixtures thereof. Oftentimes, titanium dioxide grades used in the aqueous coating composition are surface modified with various inorganic oxides, such as silicates, aluminates and zirconates. Aluminum silicate, nepeline syenite, mica, calcium carbonate, and/or diatomaceous earth can also be employed.

The type and amount of pigments present in the aqueous coating composition of the present disclosure dictate the performance properties, such as gloss, permeability, scrub resistance, tensile strength, etc. of the dried film. Hence, coatings are characterized by their pigment volume concentration (PVC). The PVC is a percentage and represents a volume ratio of pigment to total solids present in the dried film. PVC is defined as:

PVC %=Pigment Volume/(Pigment Volume+Latex Volume)×100

The point at which all voids between pigment particles are just filled with the film forming polymer is called the critical pigment-volume concentration (CPVC).

The aqueous coating composition of the present disclosure has a PVC upper limit of about 85% by weight. In one non-limiting embodiment of the present disclosure, the aqueous coating composition has a PVC upper limit of about 75% by weight. In another non-limiting embodiment of the present disclosure, the aqueous protective coating has a PVC upper limit of about 65% by weight. Similarly, the aqueous coating composition of the present disclosure has a PVC lower limit of about 10% by weight. In another non-limiting embodiment of the present disclosure, the aqueous coating composition has a PVC lower limit of about 20% by weight. More particularly, when the latex paint is a high gloss paint, the PVC is from about 15% to about 30% by weight; when the paint is a semi-gloss paint, the PVC is from about 20% to about 35% by weight; and when it is a flat paint, the PVC is from about 40% to about 85% by weight. The pigment can be added to the aqueous coating composition in dry powder form or in slurry form.

The balance of the aqueous coating composition is water. The water can be present in the film forming polymer dispersion and in other components of the aqueous coating composition. Alternatively, water can also be added separately to the aqueous coating composition.

The aqueous coating composition of the present disclosure can further comprise at least one additive. Examples of such additives can include, but are not limited to, surfactants; dispersants such as polyphosphates, amino alcohols, and acrylic copolymers; thickeners; anticaking agents; antifoaming agents such as nonsilicone and silicone types; plasticizers; extenders; preservatives; hydrophobic agents including waxes, silicones, and hydrocarbons; compatibilizers; adhesion promoters; crosslinkers; biocides; mildewcides; defoamers such as nonsilicone and silicone types; co-solvents; coalescents such as glycol ethers/esters; and any combinations thereof. These additives may be used in a manner and amount as known in the art of conventional aqueous coating compositions.

The aqueous coating composition described herein may be used in a variety of applications. In particular, the rheology modifier composition of the present disclosure is useful in all kinds of coatings such as decorative and protective coatings for architectural surfaces, for examples, walls, ceilings, doors, trim and the like; paper coatings; coatings for drywall, masonry, wood, metal, plastics, and primed surfaces and the like. In one non-limiting embodiment of the present disclosure, the coating composition is an architectural coating composition for interior and/or exterior architectural surfaces.

Another aspect of the present disclosure provides a method of preparing the aqueous coating composition of the present disclosure wherein the method comprises mixing or blending of at least one film forming polymer, the rheology modifier composition of the present disclosure, and water under agitation. Pigments may advantageously be added to provide aqueous architectural coatings. The additives described hereinabove can also be added in any suitable order to the film forming polymer, the rheology modifier composition of the present disclosure, pigment, or combinations thereof.

The aqueous coating composition is a stable fluid that can be applied to a wide variety of surfaces materials as a protective coating. Examples of such materials can include, but are not limited to, paper, wood, concrete, metal, glass, ceramics, plastics, plaster, roofing substrates such as asphaltic coatings, roofing felts and foamed polyurethane insulation; or to previously painted, primed, undercoated, worn, or weathered substrates.

Still another aspect of the present disclosure provides a method of applying the aqueous coating composition of the present disclosure to variety of surfaces. The aqueous coating composition can be applied to one or more surfaces by a variety of conventional methods well known to those skilled in the art. Examples of such method of applications can include, but are not limited to, application by aerosol spray, brush, roller, airless spray, air-assisted spray, electrostatic spray, high volume low pressure (HVLP) spray, and the like.

The rheology modifier composition of the present disclosure beneficially impacts certain rheological characteristics of paint formulations such as thickening efficiency, sag resistance and the like. The present inventors have surprisingly found out that these compositions comprising the blend of inverse emulsion of acrylamide polymer and cellulose ether demonstrates some unique and unanticipated attributes such as improved efficiency (cost in use) and thickening efficiency with similar or improved application performance such as better dilution tolerance and improved hiding compared to pure acrylamide polymers or traditional non-associative thickeners such as cellulosic. These rheology modifier compositions enhance or improve overall thickening efficiency (Stormer, Brookfield and ICI viscosities) of a paint formulation, and are also particularly suitable for difficult to thicken paint formulations such as vinyl acetate ethylene (VAE) latex paint. Additionally, the present rheology modifier compositions also provide a great deal of structure in architectural paints such as improved sag resistance and the like.

The following examples illustrate the presently disclosed and/or claimed inventive concept(s), parts and percentages being by weight, unless otherwise indicated. Each example is provided by way of explanation of the presently disclosed and/or claimed inventive concept(s), not limitation of the presently disclosed and/or claimed inventive concept(s). In fact, it will be apparent to those skilled in the art that various modifications and variations can be made in the presently disclosed and/or claimed inventive concept(s) without departing from the scope or spirit of the invention. For instance, features illustrated or described as part of one embodiment, can be used on another embodiment to yield a still further embodiment. Thus, it is intended that the presently disclosed and/or claimed inventive concept(s) covers such modifications and variations as come within the scope of the appended claims and their equivalents.

### EXAMPLES

### Test Methods

Unless indicated otherwise, the following test methods were utilized in the Examples that

### Thickening Efficiency Measurement

Thickening efficiency was measured by adding 0.15 wt. % based on actives of polymer samples obtained from examples into architectural coating formulation listed in Table 2. The thickening efficiency was measured by Brookfield Viscosity and Stormer Viscosity (KU) of thickened architectural coating composition.

Brookfield Viscosity was measured using a Brookfield viscometer with spindle #5 at 30 RPM and 25° C. It is expressed in mPa·s.

Stormer Viscosity was measured using a Stormer viscometer as per the standard test method ASTM D562. It is expressed in Kreb Units (KU).

ICI Viscosity was measured using an ICI cone and plate viscometer as per the standard test method ASTM D4287. It is expressed in mPa·s.

Different samples of the rheology modifier compositions of the present disclosure were prepared by blending wide variety of inverse emulsion of acrylamide polymers (PAM) and hydroxyethyl cellulose (HEC) polymers as shown in Table 1.

TABLE 1
List of acrylamide polymer inverse emulsions (PAM) and cellulosic
polymers used in the present rheology modifier compositions

| | | Polymer | % active | |
|---|---|---|---|---|
| Ingredients | Sample form | type | polymer | Source |
| Praestol N 3100 LTR | Inverse Emulsion | Non-ionic | 27.1 | Solenis |
| Praestol N3100 L | Inverse emulsion | Non-ionic | 29.5 | Solenis |
| Flopam EM230 | Inverse emulsion | Non-ionic | 39.5 | SNF |
| Praestol A3040 LAD | Inverse emulsion | Anionic | 29.1 | Solenis |
| Praestol A3015 L | Inverse emulsion | Anionic | 30.9 | Solenis |
| FPS Natrosol HEC | FPS | | 45.0 | Ashland |
| 250 HHRP | | | | |
| FPS Natrosol HEC | FPS | | 20.0 | Ashland |
| 250 HHBR | | | | |
| FPS Natrosol | FPS | | 25 | Ashland |
| 250H4BR | | | | |

### Example 1

Different samples of rheology modifier composition of Example 1 were prepared by blending inverse emulsion of acrylamide polymer (Flopam EM 230, available from SNF) and fluidized polymer suspension of hydroxyethyl cellulose (FPS HEC HHRP, available from Ashland LLC.) in weight proportions shown in Table 3. The weight proportions are based on an active polymer solid content of the acrylamide polymer and the HEC polymer. In a typical experiment, fluidized polymer suspension of hydroxyethyl cellulose (FPS HHRP, available from Ashland LLC.) was mixed with inverse emulsion of acrylamide polymer in a 8 oz glass jar and blended using Harbil mixer until homogeneous mixture thereof was obtained. The rheology modifier compositions of Example 1 were added to the paint formulation (shown in Table 2A and Table 2B) in 0.15 wt. % based on active polymer content.

The formulated aqueous coating compositions were equilibrated overnight before measuring Brookfield and Stormer viscosity responses. The Brookfield viscosity, Stormer viscosity (KU) and ICI viscosity data is shown in Table 3.

TABLE 2A
47 PVC Styrene Butyl Acrylate Base Paint
(Grind Formulation)

| | Amounts | |
|---|---|---|
| Ingredients | Lbs | Gal |
| Water | 294.00 | 35.30 |
| Proxel GXL | 2.00 | 0.21 |
| Tamol 731A | 12.00 | 1.30 |
| Strodex TH-4427 | 2.00 | 0.24 |
| Drewplus L-475 | 2.00 | 0.26 |
| AMP-95 | 1.00 | 0.13 |
| Strodex PK-90 | 1.00 | 0.08 |
| Optiwhite MX | 200.00 | 10.89 |
| Tronox CR-828 | 160.00 | 4.70 |

Proxel GXL, A biocide commercially available from Lonza Company.
Drewplus ™ L-475: A defoamer, commercially available from Ashland LLC.
Tamol ™ 731A: A dispersant, commercially available from The Dow Chemical Company.
Strodex ™ PK-90: A surfactant, commercially available from Ashland LLC.
Strodex ™ TH-4427: A surfactant, commercially available from Ashland LLC.
Tronox ® CR-828: Rutile titanium dioxide pigment, commercially available from Tronox Limited.
Optiwhite MX: Calcined aluminum silicate pigment, commercially available from Burgess pigment company.
AMP-95: Neutralizer, commercially available from Angus Chemical company.

TABLE 2B
47 PVC Styrene Butyl Acrylate Base Paint
(Let Down Formulation)

| | Amount | |
|---|---|---|
| Ingredients | lbs | gal |
| Acronal 296D | 280.00 | 32.33 |
| Optifilm 400 | 8.40 | 0.97 |
| Drewplus L475 | 2.00 | 0.26 |
| Water | 112 | 13.39 |

Acronal 296D: Styrene butyl acrylate emulsion, commercially available from Dow Chemicals
Optifilm ™ Enhancer 400: a coalescent, commercially available from Eastman Chemical Company.

TABLE 3
FPS HEC HHRP and Flopam EM 230 added to paint at 0.15 wt.%

| | | Stormer | Brookfield | |
|---|---|---|---|---|
| | Blend ratio (% w/w) | Viscosity | Viscosity | ICI |
| Examples | FPS HEC HHRP:Flopam EM230 | (KU) | (mPa · s) | (mPa · s) |
| Ex.1A | 95% FPS HEC HHRP:5% Flopam EM230 | 86 | 4,120 | 53.3 |
| Ex.1B | 90% FPS HEC HHRP:10% Flopam EM230 | 101 | 6,613 | 59.0 |
| Ex.1C | 85% FPS HEC HHRP:15% Flopam EM230 | 100 | 6,570 | 51.5 |
| Ex.1D | 80% FPS HEC HHRP:20% Flopam EM230 | 101 | 7,773 | 53.7 |
| CE.1A | 100% FPS HEC HHRP | 75 | 2120 | 50.4 |
| CE.1B | 100% Flopam EM230 | 86 | 2320 | 43.5 |

### Example 2

In this example, non-ionic acrylamide polymer inverse emulsion (PAM N3100 L) was blended with hydroxyethyl cellulose fluidized polymer suspension (FPS HHRP) in weight proportions shown in Table 4 to form different rheology modifier compositions. These compositions were added in 0.15 wt. % to the paint formulation (shown in Table 2A and Table 2B). The Stormer viscosity, Brookfield viscosity and ICI viscosity data of the paint formulation using these compositions is shown in Table 4.

TABLE 4
FPS HEC HHRP and Non-ionic Acrylamide Polymer Inverse Emulsion (PAM N3100L)
added to paint at 0.15 wt. %

| | | Stormer | Brookfield | |
|---|---|---|---|---|
| | Blend ratio (% w/w) | Viscosity | Viscosity | ICI |
| Examples | FPS HEC HHRP:PAM N3100 L | (KU) | (mPa · s) | (mPa · s) |
| Ex.2A | 95% FPS HEC HHRP:5% N3100L | 86 | 3,893 | 55.2 |
| Ex.2B | 90% FPS HEC HHRP:10% N3100 L | 89 | 5,427 | 53.3 |
| Ex.2C | 85% FPS HEC HHRP:15% N3100 L | 90 | 5,773 | 71.9 |
| Ex.2D | 80% FPS HEC HHRP:20% N3100L | 100 | 2,320 | 56.9 |
| CE.2 | 100% N3100L | 115 | 10000 | 61.7 |

### Example 3

The rheology modifier compositions of this example were prepared in the same manner as described above in Example 1, except non-ionic acrylamide polymer inverse emulsion (PAM N3100LTR) was used. The acrylamide polymer and the hydroxyethyl cellulose fluidized polymer suspension (FPS HHRP) was blended in weight proportions as shown in Table 5. These rheology modifier compositions were added in 0.15 wt. % to the paint formulation (as shown in Table 2A and Table 2B). The Stormer viscosity (KU), Brookfield viscosity and ICI viscosity data of the paint formulation using these compositions is shown in Table 5.

TABLE 5
FPS HEC HHRP and Non-ionic Inverse emulsion PAM N3100LTR added to paint at 0.15 wt. %

| | | Stormer | Brookfield | |
|---|---|---|---|---|
| | Blend ratio (% w/w) | Viscosity | Viscosity | ICI |
| Examples | FPS HEC HHRP:PAM N3100 LTR | (KU) | (mPa · s) | (mPa · s) |
| Ex.3A | 95% FPS HEC HHRP:5% N3100 LTR | 79 | 2,520 | 57.7 |
| Ex.3B | 90% FPS HEC HHRP:10% N3100 LTR | 81 | 2,493 | 63.8 |
| Ex.3C | 85% FPS HEC HHRP:15% N3100 LTR | 86 | 2,960 | 67.5 |
| Ex.3D | 80% FPS HEC HHRP:20% N3100 LTR | 95 | 4,520 | 73.1 |
| CE.3 | 100% N3100 LTR | 125 | >10,000 | 96.5 |

### Example 4

The rheology modifier compositions of this example were prepared in the same manner as described above in Example 1, except anionic acrylamide polymer inverse emulsion (PAM A3015 L) was used. The PAM A3015 L and FPS HEC HHRP were blended in weight proportions as shown in Table 6. These rheology modifier compositions were added in 0.15 wt. % to the paint formulation (as shown in Table 2A and Table 2B). The Stormer viscosity (KU), Brookfield viscosity and ICI viscosity data of the paint formulation using these compositions is shown in Table 6.

TABLE 6
FPS HEC HHRP and Anionic Inverse emulsion PAM A3015 L added to paint at 0.15 wt. %

| | | Stormer | Brookfield | |
|---|---|---|---|---|
| | Blend ratio (% w/w) | Viscosity | Viscosity | ICI |
| Example | FPS HEC HHRP:PAM A3015 L | (KU) | (mPa · s) | (mPa · s) |
| Ex.4A | 95% FPS HEC HHRP:5% A3015 L | 76 | 2,387 | 51.7 |
| Ex.4B | 90% FPS HEC HHRP:10% A3015 L | 77 | 2,453 | 55.2 |
| Ex.4C | 85% FPS HEC HHRP:15% A3015 L | 77 | 2,413 | 59.6 |
| Ex.4D | 80% FPS HEC HHRP:20% A3015 L | 76 | 2,160 | 56.7 |
| CE.4 | 100% A3015 L | 75 | 2,653 | 64.2 |

### Example 5

The rheology modifier compositions of this example were prepared in the same manner as described above in Example 1, except anionic acrylamide polymer inverse emulsion (PAM A3040 LAD) was used. The PAM A3040 LAD and FPS HEC HHRP were blended in weight proportions as shown in Table 7. These rheology modifier compositions were added in 0.15 wt. % to the paint formulation (as shown in Table 2A and Table 2B). The Stormer viscosity (KU), Brookfield viscosity and ICI viscosity data of the paint formulation using these compositions is shown in Table 7.

TABLE 7
FPS HEC HHRP and Anionic Inverse Emulsion (PAM A3040 LAD) added to paint at 0.15 wt. %

| | | Stormer | Brookfield | |
|---|---|---|---|---|
| | Blend ratio (% w/w) | Viscosity | Viscosity | ICI |
| Example | FPS HEC HHRP:PAM A3040 LAD | (KU) | (mPa · s) | (mPa · s) |
| Ex.5A | 95% FPS HEC HHRP:5% A3040 LAD | 77 | 2,307 | 52.5 |
| Ex.5B | 90% FPS HEC HHRP:10% A3040 LAD | 76 | 1,987 | 52.9 |
| Ex.5C | 85% FPS HEC HHRP:15% A3040 LAD | 74 | 1,853 | 52.3 |
| Ex.5D | 80% FPS HEC HHRP:20% A3040 LAD | 75 | 2,107 | 52.7 |
| CE.5 | 100% A3040 LAD | 67 | 1,133 | 49.8 |

### Example 6

The rheology modifier compositions of this example were prepared by blending acrylamide polymer inverse emulsion (PAM N3100L) and dry powder of hydroxyethyl cellulose (HEC H4BR, available from Ashland LLC) in various weight proportions as shown in Table 8. These rheology modifier compositions were added to the paint formulation (as shown in Table 2A and 2B) at 0.15 wt. %. The Stormer viscosity (KU), Brookfield viscosity and ICI viscosity data of the paint using these compositions is shown in Table 8.

TABLE 8
Dry powder HEC H4BR and acrylamide polymer inverse emulsion (PAM N3100L) added to paint at 0.15 wt. %

| | | Stormer | Brookfield | |
|---|---|---|---|---|
| | Blend ratio (% w/w) | Viscosity | Viscosity | ICI |
| Examples | Powder HEC H4BR:N3100L | (KU) | (mPa · s) | (mPa · s) |
| Ex.6A | 95% H4BR powder HEC:5% PAM N3100 L | 70 | 1,920 | 46.7 |
| Ex.6B | 90% H4BR powder HEC:10% PAM N3100 L | 73 | 2,427 | 46.0 |
| Ex.6C | 85% H4BR powder HEC:15% PAM N3100 L | 82 | 3,773 | 46.7 |
| Ex.6D | 80% H4BR powder HEC:20% PAM N3100 L | 92 | 6,800 | 54.0 |
| Ex.6E | 70% H4BR powder HEC:30% PAM N3100 L | 97 | 6,902 | 46.5 |
| Ex.6F | 60% H4BR powder HEC:40% PAM N3100 L | 109 | 7,920 | 48.3 |
| CE.6 | 100% Powder HEC H4BR | 55 | 7,46 | 36.7 |

### Example 7

The rheology modifier compositions of this example were prepared by blending fluidized polymer suspension of hydroxy ethyl cellulose with 20% active solid content (FPS HEC HHBR) with inverse emulsion of acrylamide polymer (PAM N3100L) in various wt. proportions as shown in Table 9. These rheology modifier compositions were added in 0.15 wt. % to the paint formulation (as shown in Table 2A and Table 2B). The Stormer viscosity (KU), Brookfield viscosity and ICI viscosity data of the paint formulation using these compositions is shown in Table 9.

TABLE 9
FPS HEC HHBR and acrylamide polymer inverse emulsion (PAM N3100L) added to paint at 0.15 wt. %

| | | Stormer | Brookfield | |
|---|---|---|---|---|
| | Blend ratio (% w/w) | Viscosity | Viscosity | ICI |
| Examples | FPS HHBR:Praestol N3100L | (KU) | (m · Pa · s) | (mPa · s) |
| Ex.7A | 95 FPS HEC HHBR:5% PAM N3100L | 90 | 6,307 | 47.1 |
| Ex.7B | 90 FPS HEC HHBR:10% PAM N3100L | 99 | 6,200 | 48.3 |
| Ex.7C | 85% FPS HEC HHBR:15% PAM N3100L | 102 | 5,427 | 47.3 |
| Ex.7D | 80% FPS HEC HHBR:20% PAM N3100L | 116 | 5,653 | 46.5 |
| Ex.7E | 70% FPS HEC HHBR:30% PAM N3100L | 115 | 6,787 | 49.6 |
| CE.7A | 100% Natrosol 250 HHBR PA powder | 73 | 1,813 | 44.4 |
| CE.7B | 100% FPS HEC HHBR | 75 | 1,920 | 46.3 |

What is claimed is:

1. A rheology modifier composition comprising a blend of
(i) 0.05 wt. % to 70.0 wt. % an inverse emulsion of acrylamide polymer; and
(ii) 30.0 wt. % to 99.95 wt. % of at least one cellulose ether.

2. The rheology modifier composition of claim 1, wherein the acrylamide polymer is a non-ionic homopolymer or an anionic copolymer or a cationic copolymer.

3. The rheology modifier composition of claim 1, wherein the acrylamide polymer is a cationic copolymer.

4. The rheology modifier composition of claim 2, wherein the anionic copolymer comprises at least one monomer having one or more acid or anhydride functional groups or combinations thereof, with one or more hetero atoms selected from the group consisting of S, N, O, and P.

5. The rheology modifier composition of claim 4, wherein the monomer is selected from the group consisting of acrylic acid, methacrylic acid, maleic acid or anhydride, itaconic acid or anhydride, crotonic acid, fumaric acid and citraconic acid.

6. The rheology modifier composition of claim 1, wherein the weight average molecular weight of said acrylamide polymer is in the range of from about 0.05 million Daltons to about 15 million Daltons.

7. The rheology modifier composition of claim 1, wherein the weight average molecular weight of said acrylamide polymer is in the range of from about 1 million Daltons to about 4 million Daltons.

8. The rheology modifier composition of claim 1, wherein the weight average molecular weight of said acrylamide polymer is in the range of from about 4 million Daltons to about 8 million Daltons.

9. The rheology modifier composition of claim 1, wherein the weight average molecular weight of said acrylamide polymer is in the range of from about 8 million Daltons to about 12 million Daltons.

10. The rheology modifier composition of claim 1, wherein the cellulose ether is a glyoxal treated or non-glyoxal treated cellulose ether selected from the group consisting of hydroxyethyl cellulose (HEC), hydroxypropyl cellulose (HPC), ethyl hydroxyethyl cellulose (EHEC), carboxymethyl cellulose (CMC), carboxymethyl hydroxyethyl cellulose (CMHEC), hydroxypropyl hydroxyethyl cellulose (HPHEC), methylcellulose (MC), methyl hydroxypropyl cellulose (MHPC), methyl hydroxyethyl cellulose (MHEC), carboxymethyl methyl cellulose (CMMC), hydrophobically modified carboxymethyl cellulose (HMCMC), hydrophobically modified hydroxyethyl cellulose (HMHEC). hydrophobically modified hydroxypropyl cellulose (HMHPC), hydrophobically modified ethyl hydroxyethyl cellulose (HMEHEC), hydrophobically modified carboxymethyl hydroxyethyl cellulose (HMCMHEC), hydrophobically modified hydroxypropyl hydroxyethyl cellulose (HMHPHEC), hydrophobically modified methyl cellulose (HMMC), hydrophobically modified methyl hydroxypropyl cellulose (HMMHPC), hydrophobically modified methyl hydroxyethyl cellulose (HMMHEC), hydrophobically modified carboxymethyl methyl cellulose (HMCMMC), cationic hydroxyethyl cellulose (cationic HEC), cationic hydrophobically modified hydroxyethyl cellulose (cationic HMHEC), and combinations thereof.

11. The rheology modifier composition of claim 10, wherein the cellulose ether is non-glyoxal treated hydroxyethyl cellulose (HEC).

12. The rheology modifier composition of claim 10, wherein the cellulose ether is glyoxal treated hydroxyethyl cellulose (HEC).

13. The rheology modifier composition of claim 10, wherein the cellulose ether is hydroxyethyl cellulose (HEC) or carboxymethyl cellulose either alone or in combination thereof.

14. The rheology modifier composition of claim 1, wherein the cellulose ether is in dry powder form or in a fluidized polymer suspension form.

15. The rheology modifier composition of claim 1, wherein the inverse emulsion of acrylamide polymer is present in an amount of from 0.05 wt. % to 50.0 wt. % or from 0.05 wt. % to 30.0 wt. %, and the cellulose ether is present in an amount of from 50.0 wt. % to 99.95 wt. % or from 70.0 wt. % to 99.95 wt. %.

16. The rheology modifier composition of claim 1, further comprising at least one associative polymer selected from the group consisting of hydrophobically modified ethoxylated urethane polymer, hydrophobically modified polyacetal-polyether polymer, hydrophobically modified alkali swellable emulsions, hydrophobically modified aminoplasts, alkali swellable emulsions and combinations thereof.

17. The rheology modifier composition of claim 16, wherein the associative polymer is a hydrophobically modified polyacetal-polyether polymer.

18. The rheology modifier composition of claim 1, wherein the composition further comprises at least one additive selected from the group consisting of surfactants; dispersants; thickeners; anticaking agents; antifoaming agents; preservatives; hydrophobic agents including waxes, silicones, and hydrocarbons; compatibilizers; adhesion promoters; crosslinkers; and combinations thereof.

19. The rheology modifier composition of claim 1, wherein the composition is a liquid blend. 20 A method of preparing the composition of claim 1 comprising blending (i) 0.05 wt. % to 70.0 wt. % of an inverse emulsion of acrylamide polymer; and (ii) 30.0 wt. % to 99.95 wt. % of at least one cellulose ether, wherein the cellulose ether is in dry powder form or in fluidized polymer suspension form.

21. The method of claim 20, wherein the inverse emulsion of acrylamide polymer is present in an amount of from 0.05 wt. % to 50.0 wt. % or from 0.05 wt. % to 30.0 wt. %, and the cellulose ether is present in an amount of from 50.0 wt. % to 99.95 wt. % or from 70.0 wt. % to 99.95 wt. %.

22. The method of claim 20, further comprising the step of blending at least one additive selected from the group consisting of surfactants; dispersants; thickeners; anticaking agents; antifoaming agents; preservatives; hydrophobic agents including waxes, silicones, and hydrocarbons; compatibilizers; adhesion promoters; crosslinkers; and combinations thereof.

23. Use of the rheology modifier composition of claim 1 in aqueous-based coatings, wherein the composition comprising a blend of (i) 0.05 wt. % to 70.0 wt. % of an inverse emulsion of acrylamide polymer; and (ii) 30.0 wt. % to 99.95 wt. % of at least one cellulose ether, wherein the cellulose ether is in dry powder form or in fluidized polymer suspension form.

24. The use of the rheology modifier composition of claim 23, wherein the inverse emulsion of acrylamide polymer is present in an amount of from 0.05 wt. % to 50.0 wt. % or from 0.05 wt. % to 30.0 wt. %, and the cellulose ether is present in an amount of from 50.0 wt. % to 99.95 wt. % or from 70.0 wt. % to 99.95 wt. %.

25. An aqueous coating composition comprising:
(ia) 0.01 wt. % to 10.0 wt. % of the rheology modifier composition of claim 1; or (ib) 0.01 wt. % to 10.0 wt. % of an inverse emulsion of acrylamide polymer, and 0.01 wt. % to 10.0 wt. % of at least one cellulose ether;
(ii) 5.0 wt. % to 85.0 wt. % of at least one film forming polymer; and
(iii) 5.0 wt. % to 15.0 wt. % of water, based on the total weight of the coating composition.

26. The aqueous coating composition of claim 25, wherein the inverse emulsion of acrylamide polymer and the cellulose ether are both present in the coating composition as a blend.

27. The aqueous coating composition of claim 25, wherein the film forming polymer is selected from the group consisting of acrylics, vinyl acrylics, and styrene-acrylics styrene-butadiene copolymers, vinyl acetate ethylenes, butadiene-acrylonitrile copolymers, epoxides, urethanes, polyamides, vinyl esters of versatic acid (VeoVa) and polyesters.

28. The aqueous coating composition of claim 25, wherein the coating composition further comprises a pigment selected from the group consisting of phthalocyanines, iron oxides, titanium dioxides, zinc oxide, indigo, hydrated aluminum oxide, barium sulfate, calcium silicate, clay, silica, talc and mixtures thereof.

29. The aqueous coating composition of claim 28, wherein the coating composition has a pigment volume concentration (PVC) in the range of from 15% to 85%.

30. The aqueous coating composition of claim 25, wherein the coating composition further comprises at least one additive selected from the group consisting of surfactants; dispersants; thickeners; anticaking agents; antifoaming agents; plasticizers; extenders; preservatives; hydrophobic agents including waxes, silicones, and hydrocarbons; compatibilizers; adhesion promoters; crosslinkers; biocides; mildewcides; defoamers; co-solvents; coalescents; and combinations thereof.

31. The aqueous coating composition of claim 25, wherein the coating composition is an architectural coating composition.
